(19) United States
(12) Patent Application Publication
(10) Pub. No.: US 2024/0384986 A1
(43) Pub. Date: Nov. 21, 2024

(54) INFORMATION PROCESSING SYSTEM AND INFORMATION PROCESSING METHOD

(71) Applicant: Sumitomo Rubber Industries, Ltd., Kobe-shi (JP)

(72) Inventors: Sho MATSUNAMI, Kobe-shi (JP); Naoki YUKAWA, Kobe-shi (JP); Takuya SATO, Kobe-shi (JP)

(73) Assignee: Sumitomo Rubber Industries, Ltd., Kobe-shi (JP)

(21) Appl. No.: 18/663,128

(22) Filed: May 14, 2024

(30) Foreign Application Priority Data
May 15, 2023 (JP) 2023-080171

(51) Int. Cl. G01B 21/02; G06K 7/14; G06K 19/077; G06T 7/60

(52) U.S. Cl. CPC G01B 21/02; G06K 7/1417; G06K 19/07764; G06T 7/60; G06T 2207/30252

(57) ABSTRACT

An information processing system and an information processing method that can allow the circumferential length of the tire inner cavity surface of a pneumatic tire to be easily identified. The information processing system can include: a first acquisition processing unit configured to acquire shape identification information used to identify a shape of a pneumatic tire; a second acquisition processing unit configured to acquire circumferential length information corresponding to a circumferential length of a tire inner cavity surface of the pneumatic tire on the basis of the shape identification information acquired by the first acquisition processing unit; and an output processing unit configured to output the circumferential length information acquired by the second acquisition processing unit.

### CROSS-REFERENCE TO RELATED APPLICATION

The present application claims priority to Japanese Patent Application No. 2023-080171, filed on May 15, 2023, the entire contents of which is incorporated herein by reference in its entirety.

### BACKGROUND

### Field

The present disclosure relates to an information processing system and an information processing method.

### Background Art

It is known that by attaching an annular sponge to the tire inner cavity surface of a pneumatic tire, it is possible to reduce road noise such as cavity resonance sound generated from the pneumatic tire during running of a vehicle (see, for example, Japanese Laid-Open Patent Publication No. 2005-254924).

Meanwhile, it is conceivable that a tire shop or the like provides a service to retrofit the sponge to the tire inner cavity surface of the pneumatic tire mounted on the vehicle of a customer.

Here, in order for a salesclerk of the tire shop to retrofit the sponge to the tire inner cavity surface of the pneumatic tire of a customer, it is necessary to accurately grasp the circumferential length of the tire inner cavity surface. However, the thickness of the tread portion of the pneumatic tire is different depending on the type of the pneumatic tire, and the circumferential length of the tire inner cavity surface of the pneumatic tire cannot be accurately grasped only with size information stamped on a sidewall of the pneumatic tire. Therefore, in order to accurately grasp the circumferential length of the tire inner cavity surface of the pneumatic tire, a work burden of identifying the type of the pneumatic tire and examining the thickness of the tread portion corresponding to the identified type of the pneumatic tire, arises for the salesclerk of the tire shop.

### SUMMARY

An information processing system according to an aspect of the present disclosure includes a first acquisition processing unit, a second acquisition processing unit, and an output processing unit. The first acquisition processing unit acquires shape identification information used to identify a shape of a pneumatic tire. The second acquisition processing unit acquires circumferential length information corresponding to a circumferential length of a tire inner cavity surface of the pneumatic tire on the basis of the shape identification information acquired by the first acquisition processing unit. The output processing unit outputs the circumferential length information acquired by the second acquisition processing unit.

### BRIEF DESCRIPTION OF THE DRAWINGS

FIG. 1 illustrates the configuration of an information processing system according to a first embodiment of the present disclosure;

FIG. 2 illustrates the configuration of a terminal apparatus of the information processing system according to the first embodiment of the present disclosure;

FIG. 3 illustrates the configuration of a server of the information processing system according to the first embodiment of the present disclosure;

FIG. 4 illustrates an example of first table data used in the information processing system according to the first embodiment of the present disclosure;

FIG. 5 is a flowchart showing an example of a first information output process executed in the information processing system according to the first embodiment of the present disclosure;

FIG. 6 illustrates the configuration of an information processing system according to a second embodiment of the present disclosure;

FIG. 7 illustrates the configuration of a terminal apparatus of the information processing system according to the second embodiment of the present disclosure;

FIG. 8 illustrates the configuration of a server of the information processing system according to the second embodiment of the present disclosure;

FIG. 9 illustrates an example of second table data used in the information processing system according to the second embodiment of the present disclosure;

FIG. 10 illustrates an example of third table data used in the information processing system according to the second embodiment of the present disclosure;

FIG. 11 illustrates an example of fourth table data used in the information processing system according to the second embodiment of the present disclosure;

FIG. 12 illustrates an example of a second information output process executed in the information processing system according to the second embodiment of the present disclosure;

FIG. 13 illustrates an example of an output screen displayed in the information processing system according to the second embodiment of the present disclosure; and

FIG. 14 illustrates another example of the output screen displayed in the information processing system according to the second embodiment of the present disclosure.

### DETAILED DESCRIPTION

Hereinafter, embodiments of the present disclosure will be described with reference to the accompanying drawings. The following embodiments are examples in which the present disclosure is embodied, and do not limit the technical scope of the present disclosure.

An object of the present disclosure, among one or more objects, can be to provide an information processing system and an information processing method that can allow the circumferential length of the tire inner cavity surface of a pneumatic tire to be easily identified.

Accordingly, according to one or more embodiments of the present disclosure, it can be possible to easily identify the circumferential length of the tire inner cavity surface of the pneumatic tire.

In information processing systems according to one or more embodiments of the present disclosure, the circumferential length information corresponding to the circumferential length of the tire inner cavity surface of the pneumatic tire can be acquired on the basis of the shape identification information used to identify the shape of the pneumatic tire, and the acquired circumferential length information can be outputted. Therefore, the user of the information processing system can easily identify the circumferential length of the tire inner cavity surface of the pneumatic tire by causing the information processing system to acquire the shape identification information.

### First Embodiment

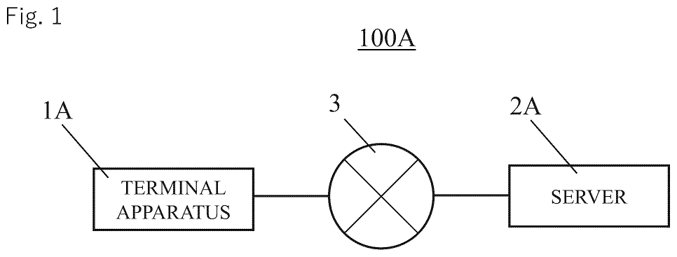

First, the configuration of an information processing system 100A according to a first embodiment of the present disclosure will be described with reference to FIG. 1.

The information processing system 100A is capable of assisting in the provision of a sound absorbing member installation service at a tire shop or the like. The sound absorbing member installation service can be regarded as a service to retrofit an annular sound absorbing member in a pneumatic tire of a vehicle of a customer.

Here, the sound absorbing member can be a member that can reduce road noise such as cavity resonance sound generated from the pneumatic tire during running of the vehicle, by being attached to the tire inner cavity surface of the pneumatic tire. For example, the sound absorbing member can be an annular sponge. For example, the sound absorbing member can be formed by joining both ends of a quadrangular prism-shaped sponge material that is long in one direction, with an adhesive, a double-sided tape, or the like.

For example, the vehicle can be an automobile such as a passenger car, a bus, and a truck. The vehicle is not limited to the automobile, and may be a motorcycle, a three-wheeled passenger car, or the like.

As shown in FIG. 1, the information processing system 100A can include a terminal apparatus 1A and a server 2A. In the information processing system 100A, the terminal apparatus 1A, and the server 2A can be connected to each other via a communication network 3 so as to be able to communicate with each other. For example, the communication network 3 can be the internet or a local area network (LAN).

The terminal apparatus 1A can be an information processing apparatus that is provided at a service-providing store, such as the tire shop, a gas station, and an automobile dealer, where the sound absorbing member installation service is provided. For example, the terminal apparatus 1A can be a personal computer. The terminal apparatus 1A may be a smartphone, a tablet terminal, a notebook computer, or the like.

The server 2A can be an information processing apparatus that outputs information for assisting in the provision of the sound absorbing member installation service, for instance, on the basis of information acquired via the terminal apparatus 1A.

### Configuration of Terminal Apparatus 1A

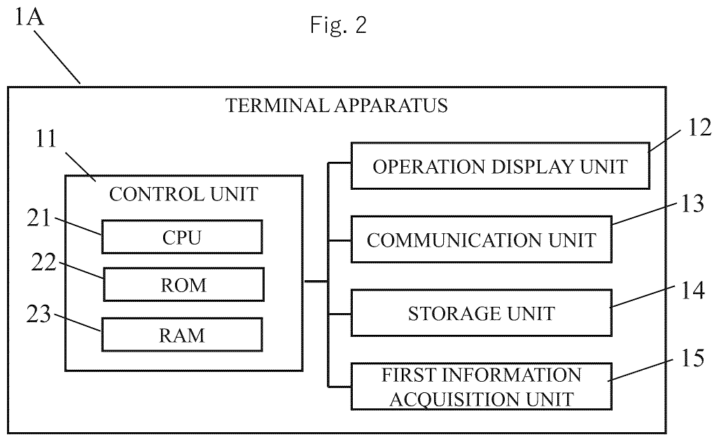

Next, the configuration of the terminal apparatus 1A will be described with reference to FIG. 2.

As shown in FIG. 2, the terminal apparatus 1A can include a control unit 11, an operation display unit 12, a communication unit 13, a storage unit 14, and a first information acquisition unit 15.

The control unit 11 can centrally control the terminal apparatus 1A. As shown in FIG. 2, the control unit 11 can include a CPU 21, a ROM 22, and a RAM 23. The CPU 21 can be a processor that executes various arithmetic processes. The ROM 22 can be a nonvolatile storage device in which information such as control programs for causing the CPU 21 to execute various processes is stored in advance. The RAM 23 can be a volatile or nonvolatile storage device that is used as a temporary storage memory (work area) for various processes executed by the CPU 21. The CPU 21 can execute various control programs stored in advance in the ROM 22. Accordingly, the CPU 21 can centrally control the terminal apparatus 1A.

The operation display unit 12 can be a user interface of the terminal apparatus 1A. The operation display unit 12 can include a first display section and a first operation section. The first display section can display various kinds of information in response to control instructions from the control unit 11. For example, the first display section can be a flat panel display such as a liquid crystal display. The first operation section can input various kinds of information to the control unit 11 in response to operations of a user. For example, the first operation section can include a keyboard, a mouse, and a touch panel.

The communication unit 13 can be a communication interface that is capable of executing data communication with external apparatuses. Specifically, the communication unit 13 can execute data communication with the server 2A via the communication network 3.

The storage unit 14 can be a nonvolatile storage device. For example, the memory unit 14 can be a storage device, such as a nonvolatile memory such as a flash memory, a solid state drive (SSD), and a hard disk drive (HDD).

The first information acquisition unit 15 can be used to acquire information from the pneumatic tire.

For example, the first information acquisition unit 15 can be a handy type RFID reader that is capable of reading information recorded on a so-called passive type RFID tag added to the pneumatic tire, from the RFID tag. For example, the first information acquisition unit 15 can be used to read trade name information indicating the trade name of the pneumatic tire and size information indicating the size of the pneumatic tire, both of which can be recorded on the passive type RFID tag. Here, the size information can be information including at least the width, the aspect ratio, and the rim diameter of the pneumatic tire.

The first information acquisition unit 15 may be a handy type bar code reader that is capable of reading information included in a bar code added to the pneumatic tire, from the bar code. In this case, the first information acquisition unit 15 may be used to read the trade name information and the size information included in the bar code.

The first information acquisition unit 15 may be a camera that is capable of taking an image of an object. For example, in the case where the terminal apparatus 1A can be a portable terminal such as a smartphone, the first information acquisition unit 15 may be the camera mounted on the portable terminal. In this case, the first information acquisition unit 15 may be used to take an image of a sidewall of the pneumatic tire on which the trade name information and the size information are stamped.

The first information acquisition unit 15 may include two or more of an RFID reader, a bar code reader, and a camera.

### Configuration of Server 2A

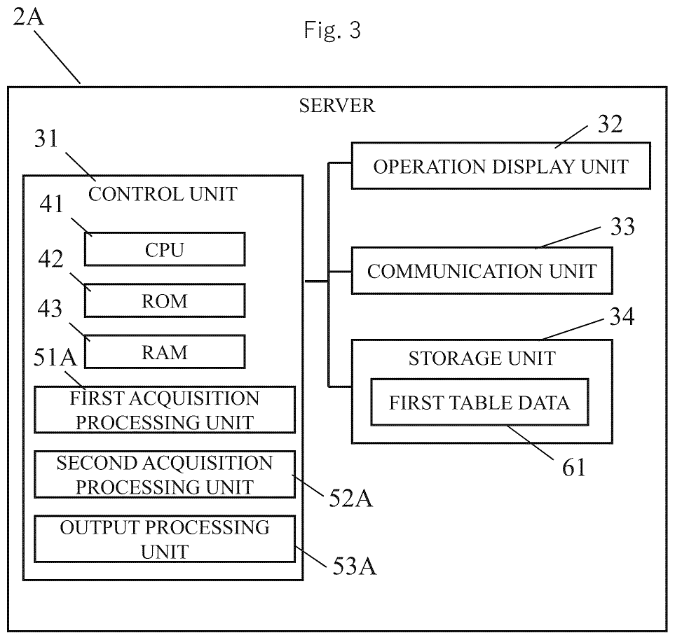

Next, the configuration of the server 2A will be described with reference to FIG. 3.

As shown in FIG. 3, the server 2A can include a control unit 31, an operation display unit 32, a communication unit 33, and a storage unit 34.

The control unit 31 can centrally control the server 2A. As shown in FIG. 3, the control unit 31 can include a CPU 41, a ROM 42, and a RAM 43. The CPU 41 can be a processor that executes various arithmetic processes. The ROM 42 can be a nonvolatile storage device in which information such as control programs for causing the CPU 41 to execute various processes is stored in advance. The RAM 43 can be a volatile or nonvolatile storage device that is used as a temporary storage memory (work area) for various processes executed by the CPU 41. The CPU 41 can execute various control programs stored in advance in the ROM 42. Accordingly, the CPU 41 centrally controls the server 2A.

The operation display unit 32 can be a user interface of the server 2A. The operation display unit 32 can include a second display section and a second operation section. The second display section displays various kinds of information in response to control instructions from the control unit 31. For example, the second display section can be a flat panel display such as a liquid crystal display. The second operation section can input various kinds of information to the control unit 31 in response to operations of the user. For example, the second operation section can include a keyboard, a mouse, and a touch panel.

The communication unit 33 can be a communication interface capable of executing data communication with external apparatuses. Specifically, the communication unit 33 can execute data communication with the terminal apparatus 1A via the communication network 3.

The storage unit 34 can be a nonvolatile storage device. For example, the memory unit 34 can be a storage device, such as a nonvolatile memory such as a flash memory, a solid state drive (SSD), and a hard disk drive (HDD).

Meanwhile, in order for a salesclerk of the service-providing store to retrofit the sound absorbing member to the tire inner cavity surface of the pneumatic tire of a customer, it may be desirable or necessary to accurately grasp the circumferential length of the tire inner cavity surface. However, the thickness of the tread portion of the pneumatic tire can be different depending on the type of the pneumatic tire, and the circumferential length of the tire inner cavity surface of the pneumatic tire may not be able to be accurately grasped only with the size information stamped on a sidewall of the pneumatic tire. Specifically, although the outer diameter of the pneumatic tire can be calculated on the basis of the width, the aspect ratio, and the rim diameter of the pneumatic tire included in the size information, since the thickness of the tread portion of the pneumatic tire is unknown, the inner diameter of the pneumatic tire may not be able to be calculated. Therefore, the circumferential length of the tire inner cavity surface of the pneumatic tire may not be able to be calculated. Therefore, in order to accurately grasp the circumferential length of the tire inner cavity surface of the pneumatic tire, a work burden of identifying the type of the pneumatic tire and examining the thickness of the tread portion corresponding to the identified type of the pneumatic tire, can arise for the salesclerk of the service-providing store.

In contrast, the information processing system 100A according to the first embodiment of the present disclosure can easily identify the circumferential length of the tire inner cavity surface of the pneumatic tire as described below.

Specifically, a first information output program for causing the control unit 31 to function as a first acquisition processing unit 51A, a second acquisition processing unit 52A, and an output processing unit 53A shown in FIG. 3 can be stored in advance in the storage unit 34 of the server 2A. The CPU 41 of the control unit 31 can function as the above respective processing units by executing the first information output program.

Some or all of the processing units included in the control unit 31 may be composed of electronic circuits. In addition, the first information output program may be a program for causing a plurality of processors to function as each processing unit shown in FIG. 3.

The first acquisition processing unit 51A can acquire shape identification information used to identify the shape of the pneumatic tire.

Here, the shape identification information can be the trade name information and the size information.

For example, the first acquisition processing unit 51A can acquire the shape identification information from the passive type RFID tag (an example of a wireless tag of the present disclosure) added to the pneumatic tire. Specifically, when the trade name information and the size information are read from the passive type RFID tag by the first information acquisition unit 15 of the terminal apparatus 1A, the first acquisition processing unit 51A can acquire the read trade name information and the read size information. The wireless tag of the present disclosure may be a so-called active type RFID tag or the like.

In the case where the first information acquisition unit 15 of the terminal apparatus 1A includes the bar code reader, the first acquisition processing unit 51A may acquire the shape identification information from the bar code (an example of a two-dimensional code of the present disclosure) added to the pneumatic tire. Specifically, when the trade name information and the size information are read from the bar code by the first information acquisition unit 15 of the terminal apparatus 1A, the first acquisition processing unit 51A may acquire the read trade name information and the read size information. The two-dimensional code of the present disclosure may be a QR code (registered trademark) or the like.

In the case where the first information acquisition unit 15 of the terminal apparatus 1A includes the camera, the first acquisition processing unit 51A may acquire the shape identification information on the basis of an image of the pneumatic tire taken by the camera (an example of an imaging unit of the present disclosure). Specifically, when an image of the sidewall of the pneumatic tire is taken by the first information acquisition unit 15 of the terminal apparatus 1A, the first acquisition processing unit 51A may acquire the trade name information and the size information from the taken image of the sidewall.

The second acquisition processing unit 52A can acquire circumferential length information corresponding to the circumferential length of the tire inner cavity surface of the pneumatic tire on the basis of the shape identification information acquired by the first acquisition processing unit 51A.

For example, the circumferential length information can be or include length information indicating the length of the sound absorbing member that can be attached to the tire inner cavity surface of the pneumatic tire. The length of the sound absorbing member that can be attached to the tire inner cavity surface of the pneumatic tire can be calculated by multiplying the circumferential length of the tire inner cavity surface of the pneumatic tire by a predetermined coefficient. For example, the coefficient can be a value determined within the range of 0.9 to 1.1.

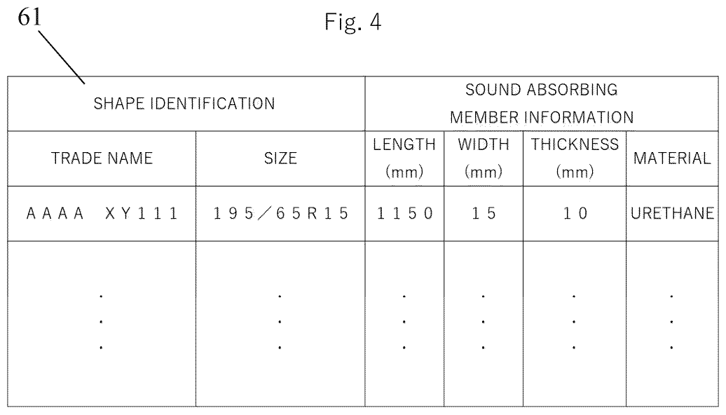

For example, the second acquisition processing unit 52A can acquire sound absorbing member information (see FIG. 4) about the sound absorbing member, on the basis of the shape identification information acquired by the first acquisition processing unit 51A. For example, the sound absorbing member information can be or include the length information, width information indicating the width of the sound absorbing member, thickness information indicating the thickness of the sound absorbing member, and/or material information indicating the material of the sound absorbing member.

For example, the first table data 61 shown in FIG. 3 and FIG. 4 can be stored in advance in the storage unit 34 of the server 2A. The first table data 61 can be or include data indicating the sound absorbing member information corresponding to a combination of the trade name information and the size information included in the shape identification information. The first table data 61 can be created by, for each combination of the trade name information and the size information, calculating the length of the sound absorbing member corresponding to this combination and determining the width, the thickness, and the material of the sound absorbing member corresponding to this combination. If the trade name of the pneumatic tire is identified, the thickness of the tread portion of the pneumatic tire can be identified. Therefore, the circumferential length of the tire inner cavity surface of the pneumatic tire and the length of the sound absorbing member that can be attached to the tire inner cavity surface can be calculated on the basis of the identified thickness of the tread portion and the size information. In addition, the width, the thickness, and the material of the sound absorbing member corresponding to the combination of the trade name information and the size information can be determined as appropriate on the basis of the size information, etc.

The second acquisition processing unit 52A can acquire the sound absorbing member information corresponding to the shape identification information acquired by the first acquisition processing unit 51A, using the first table data 61 stored in the storage unit 34.

The second acquisition processing unit 52A may acquire only the length information on the basis of the shape identification information acquired by the first acquisition processing unit 51A. In this case, the second acquisition processing unit 52A may calculate the circumferential length of the tire inner cavity surface of the pneumatic tire and the length of the sound absorbing member that can be attached to the tire inner cavity surface, on the basis of the shape identification information acquired by the first acquisition processing unit 51A.

The circumferential length information may be information indicating the circumferential length of the tire inner cavity surface of the pneumatic tire.

The shape identification information may be or include tire type information indicating the type of the pneumatic tire, and the size information. For example, the tire type information can be or include information indicating whether the pneumatic tire is a summer tire, a studless tire, or an all-season tire. In this case, the tire type information may be recorded in advance on the passive type RFID tag. The first table data 61 may be data indicating the sound absorbing member information corresponding to a combination of the tire type information and the size information included in the shape identification information. The second acquisition processing unit 52A may calculate the circumferential length of the tire inner cavity surface of the pneumatic tire on the basis of the size information and the thickness of the tread portion of the pneumatic tire identified on the basis of the tire type information. The tire type information may be information indicating whether the pneumatic tire is an all-terrain tire, a sealing tire, a run flat tire, an eco tire, a comfort tire, or a sport tire.

The shape identification information may be model number information indicating the model number of the pneumatic tire. In this case, the model number information may be recorded in advance on the passive type RFID tag. The first table data 61 may be data indicating the sound absorbing member information corresponding to the model number information. The second acquisition processing unit 52A may calculate the circumferential length of the tire inner cavity surface of the pneumatic tire on the basis of the size (width, aspect ratio, rim diameter) of the pneumatic tire and the thickness of the tread portion of the pneumatic tire identified on the basis of the model number information.

The output processing unit 53A can output the circumferential length information acquired by the second acquisition processing unit 52A.

For example, the output processing unit 53A can display the sound absorbing member information acquired by the second acquisition processing unit 52A, on the operation display unit 12 of the terminal apparatus 1A.

### First Information Output Process

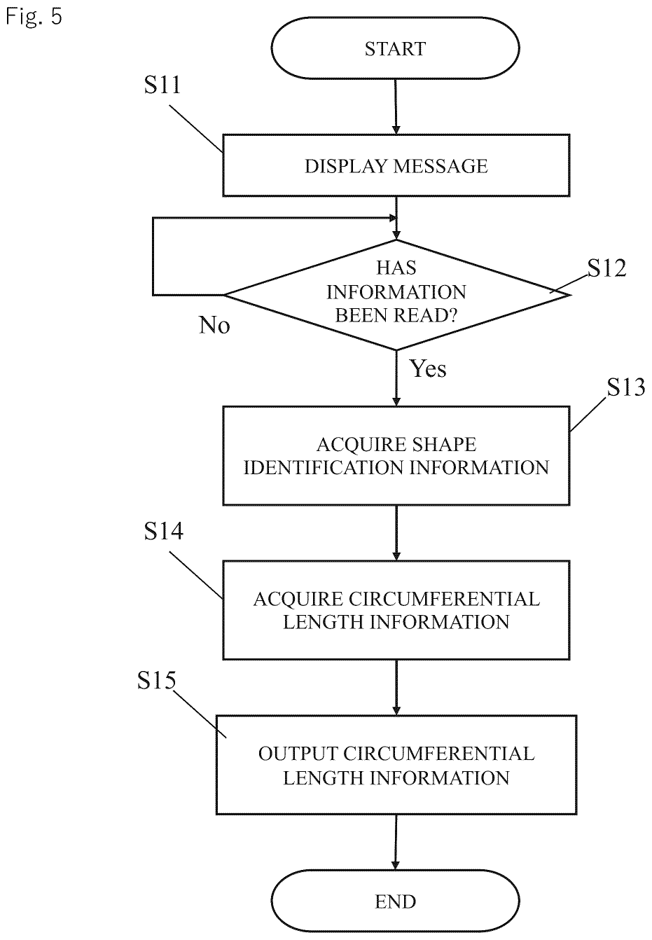

Hereinafter, an information processing method of the present disclosure will be described with reference to FIG. 5, along with an example of a procedure of a first information output process executed by the control unit 31 of the server 2A. Here, steps S11, S12 . . . represent numbers of processing procedures (steps) executed by the control unit 31. The first information output process can be executed when a predetermined operation is accepted on the operation display unit 12 of the terminal apparatus 1A.

### Step S11

First, in step S11, the control unit 31 can display, on the operation display unit 12, a message that urges the user (the salesclerk of the service-providing store) to read the passive type RFID tag added to the pneumatic tire, using the first information acquisition unit 15.

### Step S12

In step S12, the control unit 31 can determine whether or not information has been read from the passive type RFID tag by the first information acquisition unit 15.

Here, if the control unit 31 determines that information has been read from the passive type RFID tag (Yes side in S12), the control unit 31 can shift the process to step S13. In addition, if no information has been read from the passive type RFID tag (No side in S12), the control unit 31 can wait for reading of information from the passive type RFID tag in step S12.

### Step S13

In step S13, the control unit 31 can acquire the shape identification information (the trade name information and the size information) included in the information read from the passive type RFID tag by the first information acquisition unit 15. Here, the process in step S13 is an example of a first acquisition step of the present disclosure, and can be executed by the first acquisition processing unit 51A of the control unit 31.

### Step S14

In step S14, the control unit 31 can acquire the circumferential length information on the basis of the shape identification information acquired by the process in step S13. Here, the process in step S14 is an example of a second acquisition step of the present disclosure, and can be executed by the second acquisition processing unit 52A of the control unit 31.

Specifically, the control unit 31 can acquire the sound absorbing member information corresponding to the shape identification information acquired by the process in step S13, using the first table data 61 (see FIG. 4) stored in the storage unit 34.

### Step S15

In step S15, the control unit 31 can output the circumferential length information acquired by the process in step S14. Here, the process in step S15 is an example of an output step of the present disclosure, and can be executed by the output processing unit 53A of the control unit 31.

Specifically, the control unit 31 can display the sound absorbing member information acquired by the process in step S14, on the operation display unit 12 of the terminal apparatus 1A. Accordingly, the user (the salesclerk of the service-providing store) can recognize the size and the material of the sound absorbing member that can be attached to the pneumatic tire of a customer.

Thus, in the information processing system 100A, the circumferential length information corresponding to the circumferential length of the tire inner cavity surface of the pneumatic tire can be acquired on the basis of the shape identification information used to identify the shape of the pneumatic tire, and the acquired circumferential length information is outputted. Therefore, the user of the information processing system 100A (the salesclerk of the service-providing store) can easily identify the circumferential length of the tire inner cavity surface of the pneumatic tire by causing the information processing system 100A to acquire the shape identification information.

Some or all of the first acquisition processing unit 51A, the second acquisition processing unit 52A, and the output processing unit 53A may be included in the control unit 11 of the terminal apparatus 1A. The terminal apparatus 1A including all of the first acquisition processing unit 51A, the second acquisition processing unit 52A, and the output processing unit 53A can be another example of an information processing system of the present disclosure.

### Second Embodiment

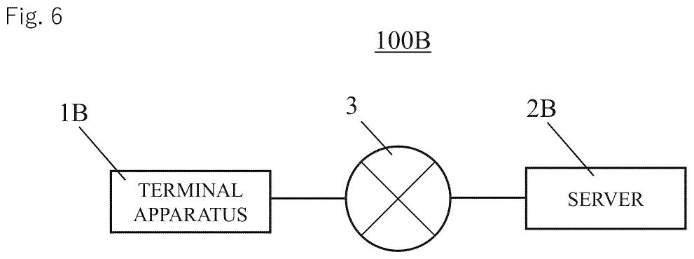

Hereinafter, the configuration of an information processing system 100B according to a second embodiment of the present disclosure will be described with reference to FIG. 6 to FIG. 11.

As shown in FIG. 6, the information processing system 100B can include a terminal apparatus 1B and a server 2B. In the information processing system 100B, the terminal apparatus 1B, and the server 2B can be connected to each other via the communication network 3 so as to be able to communicate with each other.

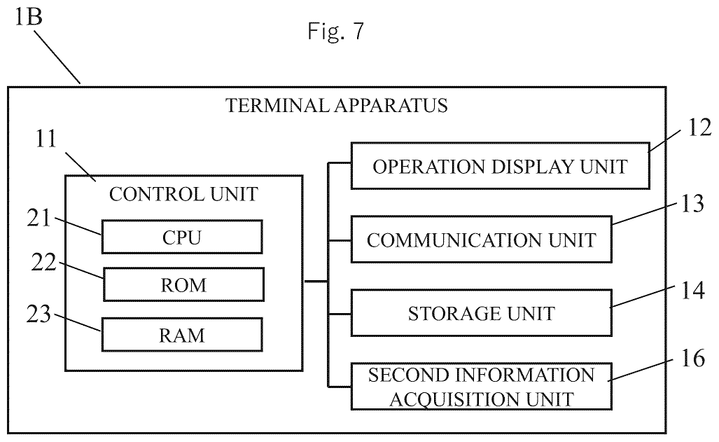

The terminal apparatus 1B can have the same configuration as that of the terminal apparatus 1A, except that a second information acquisition unit 16 shown in FIG. 7 can be included instead of the first information acquisition unit 15. Hereinafter, of the configuration of the terminal apparatus 1B, only a configuration different from that of the terminal apparatus 1A will be described.

The second information acquisition unit 16 can be used to acquire vehicle identification information of the vehicle that exists at the premises of the service-providing store, from the vehicle.

For example, the vehicle identification information can be a vehicle registration number displayed on a license plate of the vehicle. The vehicle identification information may be information with which the vehicle can be identified.

For example, the second information acquisition unit 16 can be or include a surveillance camera, for instance, placed at a location where an image of the license plate of the vehicle entering the premises of the service-providing store can be taken.

In the case where the terminal apparatus 1B is a portable terminal such as a smartphone, the second information acquisition unit 16 may be the camera mounted on the portable terminal.

The server 2B can be different from the server 2A in the configurations of the control unit 31 and the storage unit 34. The other configurations may be regarded as common to the server 2A and the server 2B. Hereinafter, of the configuration of the server 2B, only a configuration different from that of the server 2A will be described.

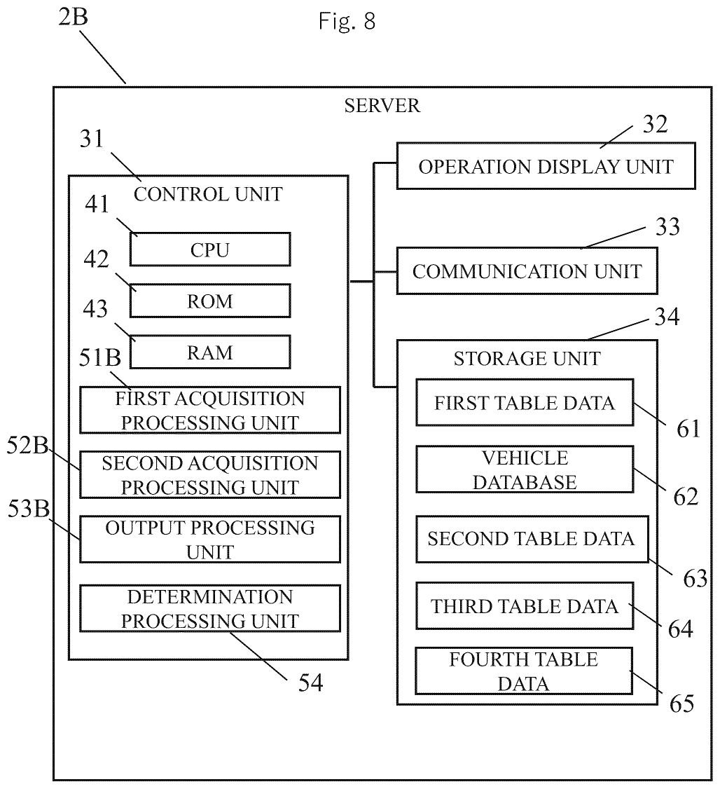

A second information output program for causing the control unit 31 to function as a first acquisition processing unit 51B, a second acquisition processing unit 52B, an output processing unit 53B, and a determination processing unit 54 shown in FIG. 8 can be stored in advance in the storage unit 34 of the server 2B. The CPU 41 of the control unit 31 can function as the above respective processing units by executing the second information output program.

Some or all of the processing units included in the control unit 31 may be composed of electronic circuits. In addition, the second information output program may be a program for causing a plurality of processors to function as each processing unit shown in FIG. 8.

The first acquisition processing unit 51B can acquire vehicle information about the vehicle on the basis of the vehicle identification information, of the vehicle on which the pneumatic tire is mounted, acquired from the vehicle. The vehicle information can be or include information including the shape identification information.

For example, a vehicle database 62 shown in FIG. 8 can be stored in advance in the storage unit 34 of the server 2B. The vehicle database 62 can include vehicle data for each vehicle registered in advance in the information processing system 100B. The vehicle data can include the vehicle identification information and the vehicle information. The vehicle information can include vehicle type information and tire information about each pneumatic tire mounted on the vehicle. The vehicle type information can be or include information indicating the type of the vehicle. Specifically, the vehicle type information can be or include information indicating whether the vehicle is a gasoline vehicle, a hybrid vehicle, or an electric vehicle. The tire information can include the shape identification information (the trade name information and the size information) and the tire type information. The type of the vehicle may include diesel vehicles, plug-in hybrid vehicles, etc. Hybrid vehicles may also be classified according to a difference in system such as series, parallel, and split systems.

For example, when an image of the license plate of the vehicle entering the premises of the service-providing store is taken by the second information acquisition unit 16 of the terminal apparatus 1B, the first acquisition processing unit 51B can acquire the vehicle identification information included in the taken image of the license plate. Then, the first acquisition processing unit 51B can acquire the vehicle information corresponding to the acquired vehicle identification information, using the vehicle database 62 stored in the storage unit 34.

The second information acquisition unit 16 of the terminal apparatus 1B may be a communication device that is capable of communicating with an in-vehicle system installed in the vehicle that exists within a predetermined communication range. In this case, the second information acquisition unit 16 may acquire the vehicle identification information registered in advance in the in-vehicle system, from the in-vehicle system. When the vehicle identification information is acquired by the second information acquisition unit 16, the first acquisition processing unit 51B may acquire the vehicle information corresponding to the vehicle identification information.

The determination processing unit 54 can determine the level of vehicle interior noise generated due to running of the vehicle, on the basis of the vehicle information acquired by the first acquisition processing unit 51B.

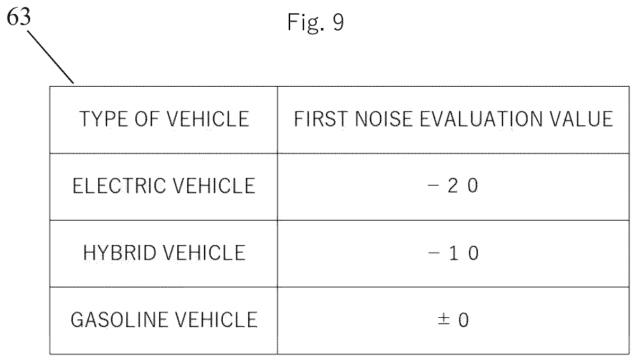

For example, second table data 63 shown in FIG. 8 and FIG. 9 can be stored in advance in the storage unit 34 of the server 2B. The second table data 63 can be or include data in which the vehicle type information and a first noise evaluation value regarding the loudness of the vehicle interior noise are associated with each other. For example, the second table data 63 can be created on the basis of the results of an experiment conducted, using a plurality of the vehicles that differ only in vehicle type, to measure noise generated in the interior of each vehicle when the vehicle is caused to run under the same running conditions (location, speed, weather, temperature, humidity, wind speed, etc.). For example, the first noise evaluation value corresponding to a gasoline vehicle may be zero. Also, the first noise evaluation value corresponding to a type of vehicle other than a gasoline vehicle can be a value obtained by subtracting a measured value, corresponding to a gasoline vehicle (reference value), acquired by the above experiment from a measured value, corresponding to the other type of vehicle, acquired by the above experiment.

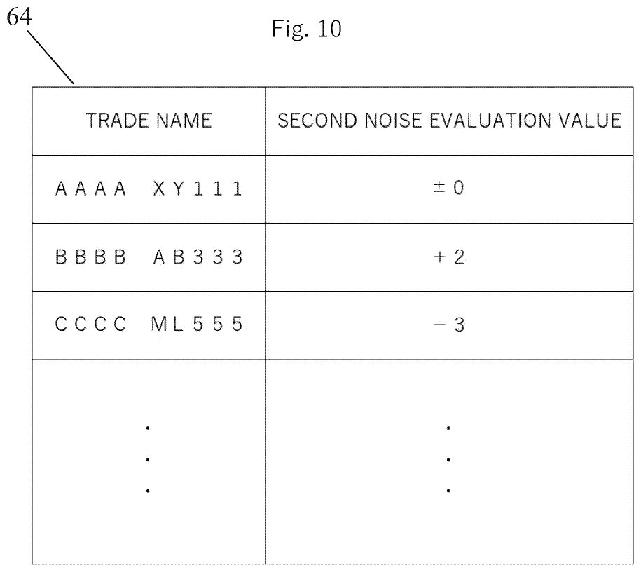

Also, third table data 64 shown in FIG. 8 and FIG. 10 can be stored in advance in the storage unit 34 of the server 2B. The third table data 64 can be or include data in which the trade name information and a second noise evaluation value regarding the loudness of the vehicle interior noise are associated with each other. For example, the third table data 64 can be created on the basis of the results of an experiment conducted, using a plurality of the vehicles that differ only in the trade name of the pneumatic tires mounted thereon, to measure noise generated in the interior of each vehicle when the vehicle is caused to run under the same running conditions (location, speed, weather, temperature, humidity, wind speed, etc.). For example, the second noise evaluation value corresponding to a trade name “AAAAXY111” (see FIG. 10) may be zero. Also, the second noise evaluation value corresponding to a trade name other than the trade name “AAAAXY111” can be a value obtained by subtracting a measured value, corresponding to the trade name “AAAAXY111” (reference value), acquired by the above experiment from a measured value, corresponding to the other trade name, acquired by the above experiment.

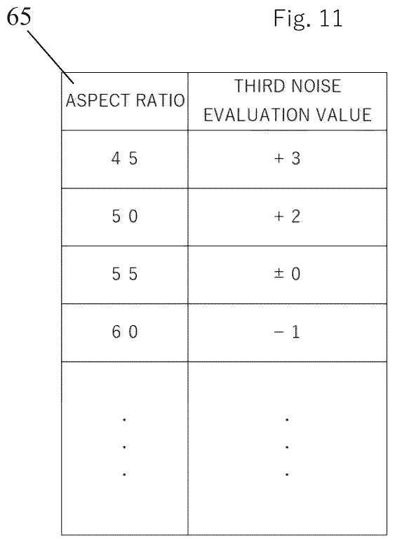

Also, fourth table data 65 shown in FIG. 8 and FIG. 11 can be stored in advance in the storage unit 34 of the server 2B. The fourth table data 65 can be or include data in which the aspect ratio included in the size information and a third noise evaluation value regarding the loudness of the vehicle interior noise are associated with each other. For example, the fourth table data 65 can be created on the basis of the results of an experiment conducted, using a plurality of the vehicles that differ only in the aspect ratio of the pneumatic tires mounted thereon, to measure noise generated in the interior of each vehicle when the vehicle is caused to run under the same running conditions (location, speed, weather, temperature, humidity, wind speed, etc.). For example, the third noise evaluation value corresponding to an aspect ratio of 55 percent may be zero. Also, the third noise evaluation value corresponding to an aspect ratio other than an aspect ratio of 55 percent can be a value obtained by subtracting a measured value, corresponding to an aspect ratio of 55 percent (reference value), acquired by the above experiment from a measured value, corresponding to the other aspect ratio, acquired by the above experiment.

For example, the determination processing unit 54 can acquire the first noise evaluation value corresponding to the vehicle type information included in the vehicle information, using the second table data 63. The determination processing unit 54 can also acquire the second noise evaluation value corresponding to the trade name information included in the vehicle information, using the third table data 64. The determination processing unit 54 can also acquire the third noise evaluation value corresponding to the aspect ratio of the pneumatic tire included in the vehicle information, using the fourth table data 65. Then, the determination processing unit 54 can calculate a noise estimate value X based on the vehicle information, using the following equation (1), and can acquire the calculated noise estimate value X as a value indicating the level of the vehicle interior noise. “X” included in the equation (1) can indicate the noise estimate value X. “A” included in the equation (1) can indicate the first noise evaluation value. “B” included in the equation (1) can indicate the second noise evaluation value. “C” included in the equation (1) can indicate the third noise evaluation value. “D” included in the equation (1) can indicate a measurement result of noise generated in the interior of a reference vehicle, on which predetermined reference tires are mounted, when the reference vehicle is caused to run under predetermined reference running conditions. The reference tires can each be the pneumatic tire whose trade name is “AAAAXY111” and whose aspect ratio is 55 percent, for instance. The reference vehicle can be a gasoline vehicle. The reference running conditions can be preferably the same as the running conditions for the vehicles in the experiments conducted when the second table data 63, the third table data 64, and the fourth table data 65 are created. “k1,” “k2,” and “k3” included in the equation (1) indicate coefficients that can be set as appropriate, respectively.

$$X = ( k 1 \times A ) + ( k 2 \times B ) + ( k 3 \times C ) + D \qquad ( 1 )$$

The determination processing unit 54 may calculate the noise estimate value X using any one or two of the first noise evaluation value, the second noise evaluation value, and the third noise evaluation value. In addition, the determination processing unit 54 may acquire a fourth noise evaluation value, regarding the loudness of the vehicle interior noise, corresponding to the tire type information included in the vehicle information instead of the second noise evaluation value corresponding to the trade name information included in the vehicle information.

The vehicle information may include vehicle dimension information, vehicle weight information, body type information, drive system information, etc. The vehicle dimension information can be or include information indicating the dimensions (overall length, overall width, overall height, etc.) of the vehicle. The vehicle weight information can be or include information indicating the weight of the vehicle. The body type information can be or include information indicating the body type of the vehicle such as sedan, coupe, convertible, station wagon, van, minivan, SUV, hatchback, and light car. The drive system information can be or include information indicating the drive system of the vehicle such as 4-wheel drive, 2-wheel drive (FF), 2-wheel drive (FR), 2-wheel drive (MR), and 2-wheel drive (RR). The determination processing unit 54 may determine the level of the vehicle interior noise using any one or more of the vehicle dimension information, the vehicle weight information, the body type information, and/or the drive system information.

The determination processing unit 54 may determine the level of the vehicle interior noise using a determination model trained on the basis of training data including the vehicle information and the measured values of the vehicle interior noise. The determination model can be a trained model that has learned the relationship between the measured values of the vehicle interior noise measured in the vehicle when the vehicle is caused to run under predetermined running conditions and each piece of information included in the vehicle information. The determination model can output the noise evaluation value (objective variable) indicating the level of the vehicle interior noise, in response to an input of the vehicle information (explanatory variable).

The second acquisition processing unit 52B can acquire the circumferential length information on the basis of the shape identification information acquired by the first acquisition processing unit 51B.

For example, the second acquisition processing unit 52B can acquire the sound absorbing member information corresponding to the shape identification information acquired by the first acquisition processing unit 51B, using the first table data 61 stored in the storage unit 34.

The output processing unit 53B can output the circumferential length information acquired by the second acquisition processing unit 52B.

Here, if the level of the vehicle interior noise determined by the determination processing unit 54 is equal to or lower than a reference level, the output processing unit 53B can output this fact and the circumferential length information. If the level of the vehicle interior noise determined by the determination processing unit 54 exceeds the reference level, the output processing unit 53B may not output the circumferential length information. For example, the reference level can be set on the basis of the results of examination of the relationship between the loudness of the vehicle interior noise and the ease with which cavity resonance sound is perceived. For example, the examination can be conducted by causing a plurality of randomly selected subjects to experience a plurality of vehicle interior environments having different loudness of the vehicle interior noise from each other, and causing the subjects to answer whether or not the subjects are bothered by the cavity resonance sound in each vehicle interior environment. The reference level may be set arbitrarily according to a predetermined operation on the operation display unit 32.

Accordingly, it can be possible to output the circumferential length information only when the vehicle of a customer visiting the service-providing store is a vehicle in which noise different from cavity resonance sound is less likely to be generated, that is, a vehicle in which cavity resonance sound is likely to be perceived by occupants. In other words, it can be possible to output the circumferential length information only when a customer visiting the service-providing store is a customer who is likely to be interested in the sound absorbing member. Therefore, by performing sales of the sound absorbing member installation service only for customers to which the circumferential length information is outputted, the salesclerk of the service-providing store can efficiently perform the sales.

For example, if the level of the vehicle interior noise determined by the determination processing unit 54 is equal to or lower than the reference level, the output processing unit 53B can output the result of the determination by the determination processing unit 54 together with this fact and the circumferential length information. Accordingly, the salesclerk of the service-providing store can be allowed to recognize the degree to which customers visiting the service-providing store are likely to be interested in the sound absorbing member.

For example, the output processing unit 53B can display the result of the determination by the determination processing unit 54, the reference level, the fact that the result of the determination by the determination processing unit 54 is equal to or lower than the reference level, and the sound absorbing member information acquired by the second acquisition processing unit 52B, on the operation display unit 12 of the terminal apparatus 1B.

The output processing unit 53B may not necessarily output the result of the determination by the determination processing unit 54. If the level of the vehicle interior noise determined by the determination processing unit 54 is equal to or lower than the reference level, the output processing unit 53B may output only the circumferential length information or the sound absorbing member information. The output processing unit 53B may output the circumferential length information or the sound absorbing member information regardless of whether or not the level of the vehicle interior noise determined by the determination processing unit 54 is equal to or lower than the reference level. In this case, the control unit 31 may not necessarily include the determination processing unit 54. The first acquisition processing unit 51B may acquire only the shape identification information on the basis of the vehicle identification information.

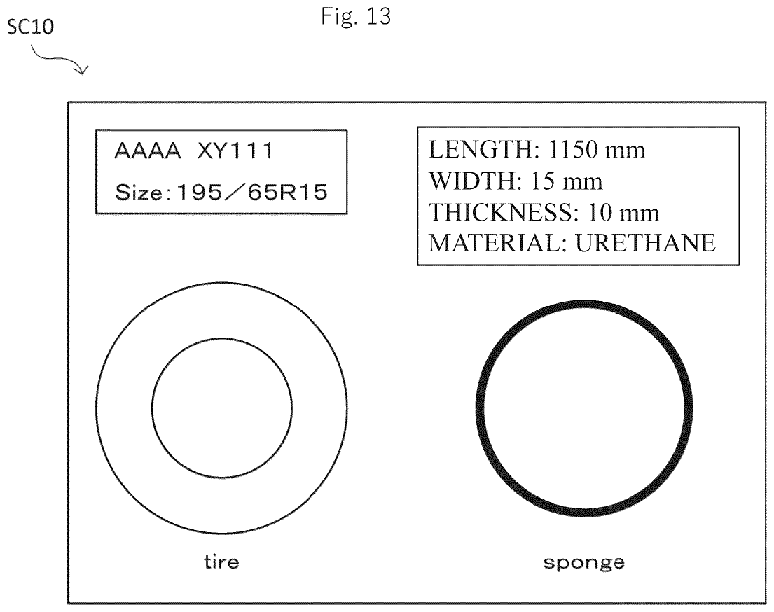

The output processing unit 53B may output the shape identification information and the sound absorbing member information about the sound absorbing member including the circumferential length information. For example, the output processing unit 53B may display an output screen SC10 (see FIG. 13) including the shape identification information and the sound absorbing member information, on the operation display unit 12 of the terminal apparatus 1B. Accordingly, the salesclerk of the service-providing store can easily identify the sound absorbing member that can be attached to the tire inner cavity surface of the pneumatic tire.

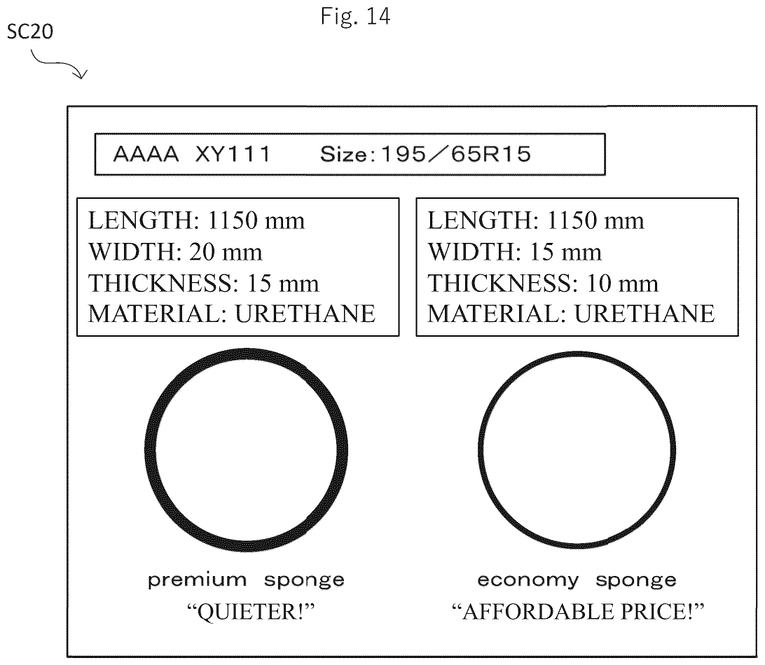

The first table data 61 (see FIG. 4) may be or include data in which a plurality of pieces of the sound absorbing member information in which the circumferential length information is the same is associated with one piece of the shape identification information. In this case, the output processing unit 53B may output the plurality of pieces of the sound absorbing member information in which the circumferential length information is the same. For example, the output processing unit 53B may display an output screen SC20 (see FIG. 14) including the shape identification information and the plurality of pieces of the sound absorbing member information in which the circumferential length information is the same, on the operation display unit 12 of the terminal apparatus 1B. Accordingly, the salesclerk of the service-providing store can present, to a customer, a plurality of candidates for the sound absorbing member that can be attached to the tire inner cavity surface of the pneumatic tire. Therefore, it can be possible to provide the sound absorbing member that more closely matches the needs of the customer.

### Second Information Output Process

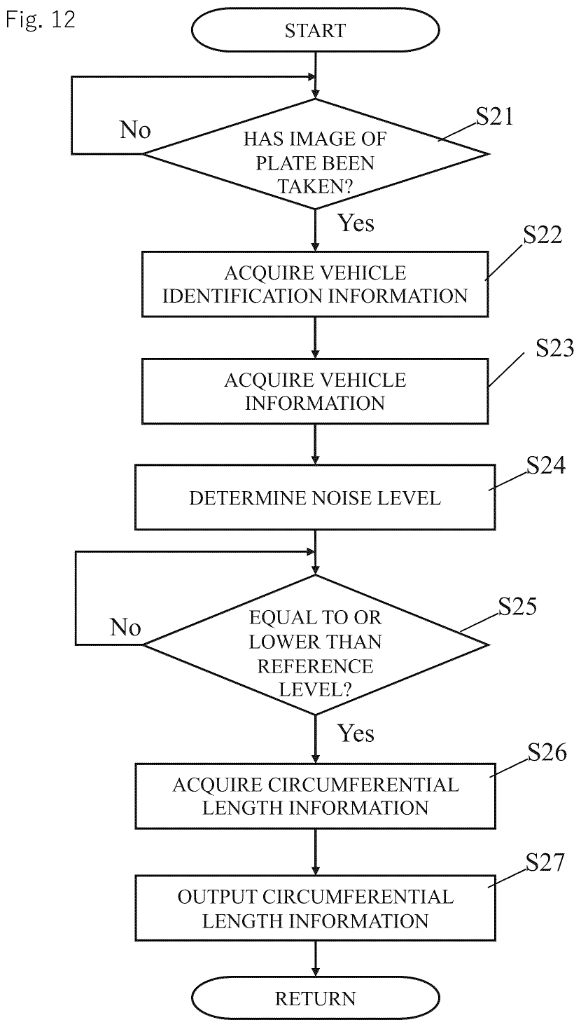

Hereinafter, an example of a procedure of a second information output process executed by the control unit 31 of the server 2B will be described with reference to FIG. 12.

### Step S21

First, in step S21, the control unit 31 can determine whether or not an image of the license plate of the vehicle entering the premises of the service-providing store has been taken by the second information acquisition unit 16 of the terminal apparatus 1B.

Here, if the control unit 31 determines that an image of the license plate of the vehicle has been taken (Yes side in S21), the control unit 31 can shift the process to step S22. If no image of the license plate of the vehicle has been taken (No side in S21), the control unit 31 can wait for an image of the license plate of the vehicle to be taken in step S21.

### Step S22

In step S22, the control unit 31 can acquire the vehicle identification information included in the image of the license plate of the vehicle taken by the second information acquisition unit 16 of the terminal apparatus 1B.

### Step S23

In step S23, the control unit 31 can acquire the vehicle information on the basis of the vehicle identification information acquired by the process in step S22. Here, the process in step S23 can be executed by the first acquisition processing unit 51B of the control unit 31.

Specifically, the control unit 31 can acquire the vehicle information corresponding to the acquired vehicle identification information, using the vehicle database 62 stored in the storage unit 34.

### Step S24

In step S24, the control unit 31 can determine the level of the vehicle interior noise on the basis of the vehicle information acquired by the process in step S23. Here, the process in step S24 can be executed by the determination processing unit 54 of the control unit 31.

Specifically, the control unit 31 can acquire the first noise evaluation value corresponding to the vehicle type information included in the vehicle information, using the second table data 63. The control unit 31 can also acquire the second noise evaluation value corresponding to the trade name information included in the vehicle information, using the third table data 64. The control unit 31 can also acquire the third noise evaluation value corresponding to the aspect ratio of the pneumatic tire included in the vehicle information, using the fourth table data 65. Then, the control unit 31 can calculate the noise estimate value X based on the vehicle information, using the above equation (1), and can acquire the calculated noise estimate value X as a value indicating the level of the vehicle interior noise.

### Step S25

In step S25, the control unit 31 can determine whether or not the level of the vehicle interior noise determined by the process in step S24 is equal to or lower than the reference level.

Here, if the control unit 31 determines that the level of the vehicle interior noise is equal to or lower than the reference level (Yes side in S25), the control unit 31 can shift the process to step S26. If the level of the vehicle interior noise is not equal to or lower than the reference level (No side in S25), the control unit 31 can shift the process to step S21.

### Step S26

In step S26, the control unit 31 can acquire the circumferential length information on the basis of the shape identification information acquired by the process in step S23. Here, the process in step S26 can be executed by the second acquisition processing unit 52B of the control unit 31.

Specifically, the control unit 31 can acquire the sound absorbing member information corresponding to the shape identification information acquired by the process in step S23, using the first table data 61 stored in the storage unit 34.

### Step S27

In step S27, the control unit 31 can output the circumferential length information acquired by the process in step S26. Here, the process in step S27 can be executed by the output processing unit 53B of the control unit 31.

Specifically, the control unit 31 can display the result of the determination by the process in step S24, the reference level, the fact that the result of the determination by the process in step S24 is equal to or lower than the reference level, and the sound absorbing member information acquired by the process in step S26, on the operation display unit 12 of the terminal apparatus 1B.

Thus, in the information processing system 100B, if the level of the vehicle interior noise determined by the determination processing unit 54 is equal to or lower than the reference level, this fact and the circumferential length information can be outputted. Accordingly, it can be possible to output the circumferential length information only when the vehicle of a customer visiting the service-providing store is a vehicle in which noise different from cavity resonance sound is less likely to be generated, that is, a vehicle in which cavity resonance sound is likely to be perceived by occupants. Therefore, it can be possible to increase the efficiency of sales of the sound absorbing member installation service performed by the salesclerk of the service-providing store.

The embodiments of the present disclosure described above can include disclosure items (1) to (10) described below.

A disclosure item (1) is an information processing system including: a first acquisition processing unit configured to acquire shape identification information used to identify a shape of a pneumatic tire; a second acquisition processing unit configured to acquire circumferential length information corresponding to a circumferential length of a tire inner cavity surface of the pneumatic tire on the basis of the shape identification information acquired by the first acquisition processing unit; and an output processing unit configured to output the circumferential length information acquired by the second acquisition processing unit.

In this system, the circumferential length information corresponding to the circumferential length of the tire inner cavity surface of the pneumatic tire can be acquired on the basis of the shape identification information used to identify the shape of the pneumatic tire, and the acquired circumferential length information is outputted. Therefore, the user of the information processing system can easily identify the circumferential length of the tire inner cavity surface of the pneumatic tire by causing the information processing system to acquire the shape identification information.

A disclosure item (2) is the information processing system of the disclosure item (1), wherein the first acquisition processing unit acquires the shape identification information from a wireless tag added to the pneumatic tire.

In this system, a reader capable of reading information from the wireless tag can be used to acquire the shape identification information. Therefore, the user of the information processing system can cause the information processing system to acquire the shape identification information with a simple operation.

A disclosure item (3) is the information processing system of the disclosure item (1), wherein the first acquisition processing unit acquires the shape identification information from a two-dimensional code added to the pneumatic tire.

In this system, a reader capable of reading information from the two-dimensional code can be used to acquire the shape identification information. Therefore, the user of the information processing system can cause the information processing system to acquire the shape identification information with a simple operation.

A disclosure item (4) is the information processing system of the disclosure item (1), further including an imaging unit configured to take an image of an object, wherein the first acquisition processing unit acquires the shape identification information on the basis of an image of the pneumatic tire taken by the imaging unit.

In this system, the imaging unit can be used to acquire the shape identification information. Therefore, the user of the information processing system can cause the information processing system to acquire the shape identification information with a simple operation. In addition, the imaging unit can be caused to automatically acquire the shape identification information.

A disclosure item (5) is the information processing system of the disclosure item (1), wherein the first acquisition processing unit can acquire the shape identification information on the basis of vehicle identification information, of a vehicle on which the pneumatic tire is mounted, acquired from the vehicle.

In this system, the imaging unit or the like can be used to acquire the shape identification information. Therefore, the user of the information processing system can cause the information processing system to acquire the shape identification information with a simple operation. In addition, the imaging unit can be caused to automatically acquire the shape identification information.

A disclosure item (6) is the information processing system of the disclosure item (5), wherein the first acquisition processing unit acquires vehicle information about the vehicle on the basis of the vehicle identification information, the vehicle information includes the shape identification information, the information processing system further includes a determination processing unit configured to determine a level of vehicle interior noise generated due to running of the vehicle, on the basis of the vehicle information acquired by the first acquisition processing unit, and if the level of the vehicle interior noise determined by the determination processing unit is equal to or lower than a reference level, the output processing unit outputs the circumferential length information and a fact that the level of the vehicle interior noise determined by the determination processing unit is equal to or lower than the reference level.

In this system, if the level of the vehicle interior noise determined by the determination processing unit is equal to or lower than the reference level, this fact and the circumferential length information can be outputted. Accordingly, it can be possible to output the circumferential length information only when the vehicle of a customer visiting the service-providing store is a vehicle in which noise different from cavity resonance sound is less likely to be generated, that is, a vehicle in which cavity resonance sound is likely to be perceived by occupants. Therefore, it can be possible to increase the efficiency of sales of the sound absorbing member installation service performed by the salesclerk of the service-providing store.

A disclosure item (7) is the information processing system of the disclosure item (6), wherein the output processing unit outputs a result of the determination by the determination processing unit, together with the circumferential length information and the fact that the level of the vehicle interior noise determined by the determination processing unit is equal to or lower than the reference level.

In this system, if the level of the vehicle interior noise determined by the determination processing unit is equal to or lower than the reference level, the result of the determination by the determination processing unit can be outputted. Therefore, the salesclerk of the service-providing store is allowed to recognize the degree to which customers visiting the service-providing store may be likely to be interested in the sound absorbing member.

A disclosure item (8) is the information processing system of the disclosure item (1), wherein the circumferential length information is information indicating a length of a sound absorbing member that can be attached to the tire inner cavity surface of the pneumatic tire, and the output processing unit outputs the shape identification information and sound absorbing member information about the sound absorbing member including the circumferential length information.

With this system, the salesclerk of the service-providing store can easily identify the sound absorbing member that can be attached to the tire inner cavity surface of the pneumatic tire.

A disclosure item (9) is the information processing system of the disclosure item (8), wherein the output processing unit outputs a plurality of pieces of the sound absorbing member information in which the circumferential length information is the same.

With this system, the salesclerk of the service-providing store can present, to a customer, a plurality of candidates for the sound absorbing member that can be attached to the tire inner cavity surface of the pneumatic tire. Therefore, it can be possible to provide the sound absorbing member that more closely matches the needs of the customer.

A disclosure item (10) is an information processing method executed by a processor included in an information processing system, the information processing method including: a first acquisition step of acquiring shape identification information used to identify a shape of a pneumatic tire; a second acquisition step of acquiring circumferential length information corresponding to a circumferential length of a tire inner cavity surface of the pneumatic tire on the basis of the shape identification information acquired by the first acquisition step; and an output step of outputting the circumferential length information acquired by the second acquisition step.

With this method, it can be possible to easily identify the circumferential length of the tire inner cavity surface of the pneumatic tire, as with the information processing system of the disclosure item (1).

A disclosure item (11) can be information processing system comprising: circuitry configured to acquire shape identification information used to identify a shape of a pneumatic tire; acquire circumferential length information corresponding to a circumferential length of a tire inner cavity surface of the pneumatic tire based on the acquired shape identification information; and output the acquired circumferential length information.

A disclosure item (12) can be the information processing system according to (11), wherein the circuitry acquires the shape identification information from a wireless tag added to the pneumatic tire.

A disclosure item (13) can be the information processing system according to (11) or (12), wherein the circuitry acquires the shape identification information from a two-dimensional code added to the pneumatic tire.

A disclosure item (14) can be the information processing system according to any one of (11) to (13), wherein the circuitry is configured to take an image of an object, and wherein the circuitry acquires the shape identification information based on the taken image.

A disclosure item (15) can be the information processing system according to any one of (11) to (14), wherein the circuitry acquires the shape identification information based on vehicle identification information, of a vehicle on which the pneumatic tire is mounted, acquired from the vehicle.

A disclosure item (16) can be the information processing system according to any one of (11) to (15), wherein the circuitry acquires vehicle information about the vehicle based on the vehicle identification information, the vehicle information includes the shape identification information, the circuity is configured to determine a level of vehicle interior noise generated due to running of the vehicle, based on the acquired vehicle information, and under a condition where the level of the vehicle interior noise determined by the circuitry is equal to or lower than a reference level, the circuitry outputs the circumferential length information and a fact that the determined level of the vehicle interior noise is equal to or lower than the reference level.

A disclosure item (17) can be the information processing system according to any one of (11) to (16), wherein the circuitry outputs a result of the determination, together with the circumferential length information and the fact that the determined level of the vehicle interior noise is equal to or lower than the reference level.

A disclosure item (18) can be the information processing system according to any one of (11) to (17), wherein the circumferential length information is information indicating a length of a sound absorbing member that can be attached to the tire inner cavity surface of the pneumatic tire, and the circuitry outputs the shape identification information and sound absorbing member information about the sound absorbing member including the circumferential length information.

A disclosure item (19) can be the information processing system according to any one of (11) to (18), wherein the circuitry outputs a plurality of pieces of the sound absorbing member information in which the circumferential length information is the same.

A disclosure item (20) can be an information processing method executed by a processor included in an information processing system, the information processing method comprising: acquiring shape identification information used to identify a shape of a pneumatic tire; acquiring circumferential length information corresponding to a circumferential length of a tire inner cavity surface of the pneumatic tire based on the shape identification information acquired by said acquiring the shape identification information; and outputting the circumferential length information acquired by said acquiring the circumferential length information.

A disclosure item (21) can be the information processing method according to (20), wherein said acquiring the shape identification information is from a wireless tag added to the pneumatic tire.

A disclosure item (22) can be the information processing method according to (20) or (21), wherein said acquiring the shape identification information is from a two-dimensional code added to the pneumatic tire.

A disclosure item (23) can be the information processing method according to any one of (20) or (22), further comprising taking an image of an object, and wherein said acquiring the shape identification information is based on the taken image.

A disclosure item (24) can be the information processing method according to any one of (20) or (23), wherein said acquiring the shape identification information is based on vehicle identification information, of a vehicle on which the pneumatic tire is mounted, acquired from the vehicle.

A disclosure item (25) can be the information processing method according to any one of (20) or (24), wherein said acquiring the vehicle information about the vehicle is based on the vehicle identification information, the vehicle information includes the shape identification information, the method further comprises: determining a level of vehicle interior noise generated due to running of the vehicle, based on the acquired vehicle information; and under a condition where the determined level of the vehicle interior noise is equal to or lower than a reference level, outputting outputs the circumferential length information and a fact that the determined level of the vehicle interior noise is equal to or lower than the reference level.

A disclosure item (26) can be the information processing method according to any one of (20) or (25), further comprising outputting a result of the determination, together with the circumferential length information and the fact that the determined level of the vehicle interior noise is equal to or lower than the reference level.

A disclosure item (27) can be the information processing method according to any one of (20) or (26), wherein the circumferential length information is information indicating a length of a sound absorbing member that can be attached to the tire inner cavity surface of the pneumatic tire, and the method further comprises outputting the shape identification information and sound absorbing member information about the sound absorbing member including the circumferential length information.

A disclosure item (28) can be the information processing method according to any one of (20) or (27), further comprising outputting a plurality of pieces of the sound absorbing member information in which the circumferential length information is the same.

A disclosure item (29) can be a non-transitory computer-readable storage medium having stored thereon instructions that, when executed by one or more processors, causes the one or more processors to perform a method comprising: acquiring shape identification information used to identify a shape of a pneumatic tire; acquiring circumferential length information corresponding to a circumferential length of a tire inner cavity surface of the pneumatic tire based on the shape identification information acquired by said acquiring the shape identification information; and outputting the circumferential length information acquired by said acquiring the circumferential length information.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. An information processing system comprising:
circuitry configured to
acquire shape identification information used to identify a shape of a pneumatic tire;
acquire circumferential length information corresponding to a circumferential length of a tire inner cavity surface of the pneumatic tire based on the acquired shape identification information; and
output the acquired circumferential length information.

2. The information processing system according to claim 1, wherein the circuitry acquires the shape identification information from a wireless tag added to the pneumatic tire.

3. The information processing system according to claim 1, wherein the circuitry acquires the shape identification information from a two-dimensional code added to the pneumatic tire.

4. The information processing system according to claim 1, wherein the circuitry is configured to take an image of an object, and
wherein the circuitry acquires the shape identification information based on the taken image.

5. The information processing system according to claim 1, wherein the circuitry acquires the shape identification information based on vehicle identification information, of a vehicle on which the pneumatic tire is mounted, acquired from the vehicle.

6. The information processing system according to claim 5, wherein
the circuitry acquires vehicle information about the vehicle based on the vehicle identification information,
the vehicle information includes the shape identification information,
the circuity is configured to determine a level of vehicle interior noise generated due to running of the vehicle, based on the acquired vehicle information, and
under a condition where the level of the vehicle interior noise determined by the circuitry is equal to or lower than a reference level, the circuitry outputs the circumferential length information and a fact that the determined level of the vehicle interior noise is equal to or lower than the reference level.

7. The information processing system according to claim 6, wherein the circuitry outputs a result of the determination, together with the circumferential length information and the fact that the determined level of the vehicle interior noise is equal to or lower than the reference level.

8. The information processing system according to claim 1, wherein
the circumferential length information is information indicating a length of a sound absorbing member that can be attached to the tire inner cavity surface of the pneumatic tire, and
the circuitry outputs the shape identification information and sound absorbing member information about the sound absorbing member including the circumferential length information.

9. The information processing system according to claim 8, wherein the circuitry outputs a plurality of pieces of the sound absorbing member information in which the circumferential length information is the same.

10. An information processing method executed by a processor included in an information processing system, the information processing method comprising:
acquiring shape identification information used to identify a shape of a pneumatic tire;
acquiring circumferential length information corresponding to a circumferential length of a tire inner cavity surface of the pneumatic tire based on the shape identification information acquired by said acquiring the shape identification information; and
outputting the circumferential length information acquired by said acquiring the circumferential length information.

11. The information processing method according to claim 10, wherein said acquiring the shape identification information is from a wireless tag added to the pneumatic tire.

12. The information processing method according to claim 10, wherein said acquiring the shape identification information is from a two-dimensional code added to the pneumatic tire.

13. The information processing method according to claim 10, further comprising taking an image of an object, and
wherein said acquiring the shape identification information is based on the taken image.

14. The information processing method according to claim 1, wherein said acquiring the shape identification information is based on vehicle identification information, of a vehicle on which the pneumatic tire is mounted, acquired from the vehicle.

15. The information processing method according to claim 14, wherein
said acquiring the vehicle information about the vehicle is based on the vehicle identification information,
the vehicle information includes the shape identification information,
the method further comprises:
determining a level of vehicle interior noise generated due to running of the vehicle, based on the acquired vehicle information; and
under a condition where the determined level of the vehicle interior noise is equal to or lower than a reference level, outputting outputs the circumferential length information and a fact that the determined level of the vehicle interior noise is equal to or lower than the reference level.

16. The information processing method according to claim 15, further comprising outputting a result of the determination, together with the circumferential length information and the fact that the determined level of the vehicle interior noise is equal to or lower than the reference level.

17. The information processing method according to claim 10, wherein
the circumferential length information is information indicating a length of a sound absorbing member that can be attached to the tire inner cavity surface of the pneumatic tire, and
the method further comprises outputting the shape identification information and sound absorbing member information about the sound absorbing member including the circumferential length information.

18. The information processing system according to claim 17, further comprising outputting a plurality of pieces of the sound absorbing member information in which the circumferential length information is the same.

19. A non-transitory computer-readable storage medium having stored thereon instructions that, when executed by one or more processors, causes the one or more processors to perform a method comprising:
acquiring shape identification information used to identify a shape of a pneumatic tire;
acquiring circumferential length information corresponding to a circumferential length of a tire inner cavity surface of the pneumatic tire based on the shape identification information acquired by said acquiring the shape identification information; and
outputting the circumferential length information acquired by said acquiring the circumferential length information.
